(19) United States
(12) Patent Application Publication
(10) Pub. No.: US 2003/0198470 A1
(43) Pub. Date: Oct. 23, 2003

(54) WDM assembly

(76) Inventors: Richard Lauder, Earlwood (AU); Chia Seiler, Bairnsdale (AU); Peter Chart, Balmain (AU); Brian Robert Brown, Collaroy (AU)

Correspondence Address: CHRISTIE, PARKER & HALE, LLP, 350 WEST COLORADO BOULEVARD, SUITE 500, PASADENA, CA, 91105, US

(21) Appl. No.: 10/129,000

(22) Filed: Apr. 23, 2002

(51) Int. Cl. H04B 10/24

(52) U.S. Cl. 398/42

(57) ABSTRACT

A WDM assembly comprising a WDM filter structure for multiplexing and demultiplexing optical signals and having a single fibre common connection for transmitting and receiving a WDM optical signal; a housing member for the WDM filter structure; a plurality of E/O transmitter units external to the housing member for receiving a plurality of independent electrical data signals and converting into a plurality of corresponding optical WDM channel signals; plurality of O/E receiver units external to the housing member for receiving a plurality of optical WDM channel signals and converting into a corresponding plurality of independent electrical data signals; wherein each of the E/O transmitter units and O/E receiver units is optically connected to the WDM filter structure via a single fibre link; and wherein excess fibre length in each fibre link is accommodated within the housing member, whereby each fibre length has a predetermined external fibre length between the housing member and the E/O transmitter units and the O/E receiver units.

### FIELD OF THE INVENTION

The present invention relates broadly to a WDM assembly and to a method of fabricating a WDM assembly.

### BACKGROUND OF THE INVENTION

Presently, WDM systems for optical networks are implemented primarily at a long-haul and metro-core level as opposed to the metro-access or access marketplace closer to the end-user. Those high-end WDM systems are typically fabricated from individual optoelectronic and optical components hand assembled, connected or spliced into the final assembly.

It has been recognised by the applicant that to enable the mass manufacture of WDM systems suitable for the metro-access or access marketplace, such an assembly technique/design is undesirable.

The applicants have further recognised that any modular design more suitable for mass manufacture of WDM systems for the metro-access or access marketplace must take into account additional criteria resulting from taking present WDM system designs from the typically controlled environment at the high-end implementation to outside plant (OSP) or curbside environment.

In at least preferred embodiments, the present invention seeks to provide a novel WDM assembly more suitable for the metro-access or access marketplace.

### SUMMARY OF THE INVENTION

In accordance with a first aspect of the present invention, there is provided a WDM assembly comprising:

a WDM filter structure for multiplexing and demultiplexing optical signals and having a single fibre common connection for transmitting and receiving a WDM optical signal;

a housing member for the WDM filter structure;

a plurality of E/O transmitter units external to the housing member for receiving a plurality of independent electrical data signals and converting into a plurality of corresponding optical WDM channel signals;

plurality of O/E receiver units external to the housing member for receiving a plurality of optical WDM channel signals and converting into a corresponding plurality of independent electrical data signals;

wherein each of the E/O transmitter units and O/E receiver units is optically connected to the WDM filter structure via a single fibre link; and

wherein excess fibre length in each fibre link is accommodated within the housing member, whereby each fibre length has a predetermined external fibre length between the housing member and the E/O transmitter units and the O/E receiver units.

Preferably, the WDM filter structure and the O/E receiver units are capable of tolerating an uncontrolled OSP environment.

In one embodiment, the assembly further comprises a local thermal environment structure external to the housing member, and arranged, in use, such that each E/O transmitter unit is in thermal communication with the local thermal environment structure. The local thermal environment structure may be arranged, in use, such that a local environment around each E/O transmitter unit is maintained within a constrained temperature range. The constrained temperature range may be between 40-50° C. In one embodiment, the WDM filter structure comprises a plurality of individual filter elements for the demultiplexing and multiplexing. The filter elements may be discrete components connected via single fibre links. Preferably, the fibre links comprise recoated fibre splices. Advantageously, each E/O transmitter unit is connected to an associated one of the discrete filter elements via the single fibre links. The single fibre links between the E/O transmitter units and the associated filter elements may comprise recoated fibre splices. Preferably, the recoated fibre splices are located inside the housing member. Accordingly, use of an external fibre splice tray which may otherwise be required can be avoided.

Each O/E receiver unit may be connected to an associated one of discrete filter elements inside the WDM filter module via single fibre links. The single fibre links between the O/E receiver units and the associated discrete filter elements preferably comprise recoated fibre splices. Preferably, the recoated fibre splices between the O/E the receiver units and the filter elements are located inside the housing element.

In one embodiment, at least one of the single fibre links between one O/E receiver unit and its associated filter element comprise an optical tap element located inside the housing element, and the WDM assembly further comprises a management data O/E receiver unit external to the housing element and connected to a tap output of the tap element via a single fibre link for receiving an optical management signal and converting into an electrical management signal.

In another embodiment, the WDM filter structure comprises an integral waveguide device. Preferably, the integrated waveguide device is a planar waveguide device. The fibre links between the O/E receiver units and the WDM filter structure may comprise recoated fibre splices. The recoated fibre splices between the O/E receiver units and the filter elements may be located inside the housing element.

In one embodiment, the integral waveguide device further comprises a tap element for optically tapping into one of the WDM channel signals, and the WDM assembly further comprises a management data O/E receiver unit external to the housing element and connected to a tap output of the integrated waveguide device via a single fibre link for receiving an optical management signal and converting into an electrical management signal.

In accordance with a second aspect of the present invention there is provided a method of manufacturing a WDM assembly, the method comprising the steps of:

locating a WDM filter structure for multiplexing and demultiplexing optical signals in a housing member for the WDM filter structure;

optically connecting a plurality of the E/O transmitter units and a plurality of O/E receiver units to the WDM filter structure via a single fibre links; and

accommodating excess fibre length in each fibre link within the housing member, whereby each fibre length is adjusted to a predetermined external fibre length between the housing member and the E/O transmitter units and the O/E receiver units.

### BRIEF DESCRIPTION OF THE DRAWINGS

Preferred embodiments of the present invention will now be described, by way of example only, with reference to the accompanying drawings.

FIG. 1 shows a schematic drawing of a WDM assembly embodying the present invention.

FIGS. 2A and B show schematic drawings of portions of WDM assemblies embodying the present invention.

FIGS. 3A to C show schematic drawings illustrating a process for assembly of a WDM assembly embodying the present invention.

FIG. 4 shows parts of a WDM network node module embodying the present invention.

### DETAILED DESCRIPTION OF THE EMBODIMENTS

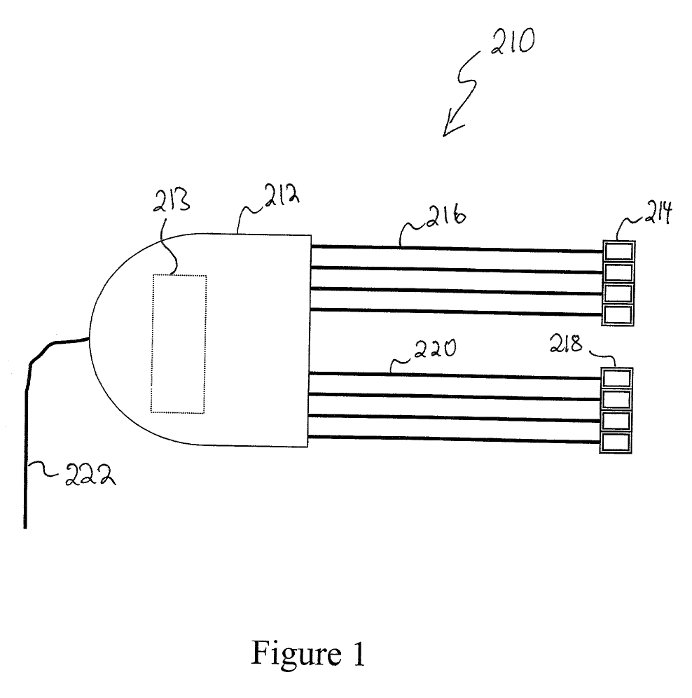

In FIG. 1, a WDM assembly 210 comprises a housing member in the form of a casing 212 containing a WDM filter structure 213 for effecting multiplexing and demultiplexing of a WDM signal.

The WDM assembly further comprises a plurality of laser transmitters, e.g. 214, fibre connected to the WDM filter structure 213 via appropriate feedthroughs in the casing 212 through a plurality of fibre links, e.g. 216.

The WDM assembly 210 further comprises a plurality of O/E receiver units e.g. 218, fibre connected to the WDM filter structures 213 via appropriate feedthroughs in the casing 212 through a plurality of fibre links e.g. 220.

The WDM assembly 210 further comprises a single fibre common port link 222 for bi-directional optical transmission to and from the WDM filter structure 213 through an appropriate feedthrough in the casing 212, when the WDM assembly 210 is installed at an optical network node.

It is noted that the WDM filter structure 213 can take many forms in different embodiments of the present invention. For example, the WDM structure 213 in one example can comprise a plurality of individual thin film filters interconnected through suitable optical fibre links. However, it will be appreciated that alternative WDM filter structures can be used in different embodiments, including e.g. an integral waveguide device.

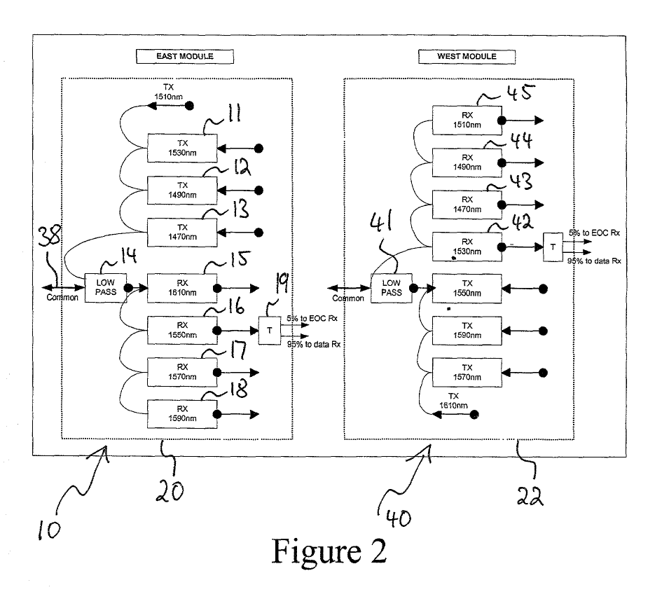

In FIG. 2A, a WDM bi-directional “east” module 10 comprises a plurality of filters 11 to 18 contained in a casing 20. In the example embodiment, the filters 11 to 18 comprise thin film filters, but other filters may be used in different embodiments. The module 10 further comprises four fibre connections to transmission lasers (not shown), each set to an individual transmission wavelength, in the example embodiment 1510 nm, 1530 nm, 1490 nm and 1470 nm respectively.

The module 10 further comprises fibre connections to receiver units (not shown) external to the casing 20 for receiving data content on individual wavelength channels, and a further fibre connection to a receiver unit (not shown) external to the casing 20 for receiving in-band management data content. In the example embodiment, the wavelengths of the receiver channels are 1610 nm, 1550 nm, 1570 nm, and 1590 nm.

In use, the optical signal transmitted from the respective lasers (not shown) experience different insertion losses as a result of passing through a different number of the thin film filters 11, 12, 13, and 14, before “leaving” the module 10 as the multiplexed WDM optical signal via the common fibre link 38 for transmission into an optical link/optical network (not shown) to which the module is connected.

Similarly, the optical signals received at the respective receiver units (not shown) experience different insertion losses as a result of passing through a different number of the thin film filters 14, 15, 16, 17, and 18, and an optical tap coupler 19.

After the WDM signal is transmitted at numeral 38 from the east module 10 and subsequently received at a bi-directional “west” module 40 shown in FIG. 2B, with no amplification along the transmission in the example embodiment, further insertion losses at the filter elements 41 to 44 contained in a casing 22 of the module 40 are experienced.

It will be appreciated that the above similarly applies also to the WDM channel signals transmitted from the west module 40 to the east module 10.

Thus the order of the thin film filters at the east and west modules 10, 40 influences an optical loss profile of the WDM channels for multiplexing and demultiplexing.

It has been recognised by the applicants, that if the optical losses are chosen such that the losses in the multiplexing substantially balance the losses in the demultiplexing, through suitable selection of the order of the channel filters, then such a system would minimise the dynamic range of the WDM signal only for a zero transmission link length. It has been recognised by the applicants that fibre insertion losses experienced by the individual WDM channels during transmission along the transmission link can vary significantly between channels. This is found to be of particular relevance where the wavelength spacing or spread of the WDM channels is quite large, e.g. in excess of 100 nm for coarse WDM signals like the one described in the example embodiment as shown in FIGS. 2A and 2B.

It is noted that in the example embodiment shown in FIGS. 2A and 2B, a banded architecture has been used to implement a bi-directional system. Low pass filters 14, 41 are used to “separate” the respective bands at the modules 10 and 40 respectively, i.e. the wavelength signals in one band do not pass through the filters utilised for the wavelengths signals of the other band. However, it will be appreciated by the persons skilled in the art that in different embodiments, a non-banded architecture may be used in e.g. an interleaved architecture. In such embodiments, the balancing in a bi-directional system preferably further accounts for the existence of both multiplexing and demultiplexing filters at each module.

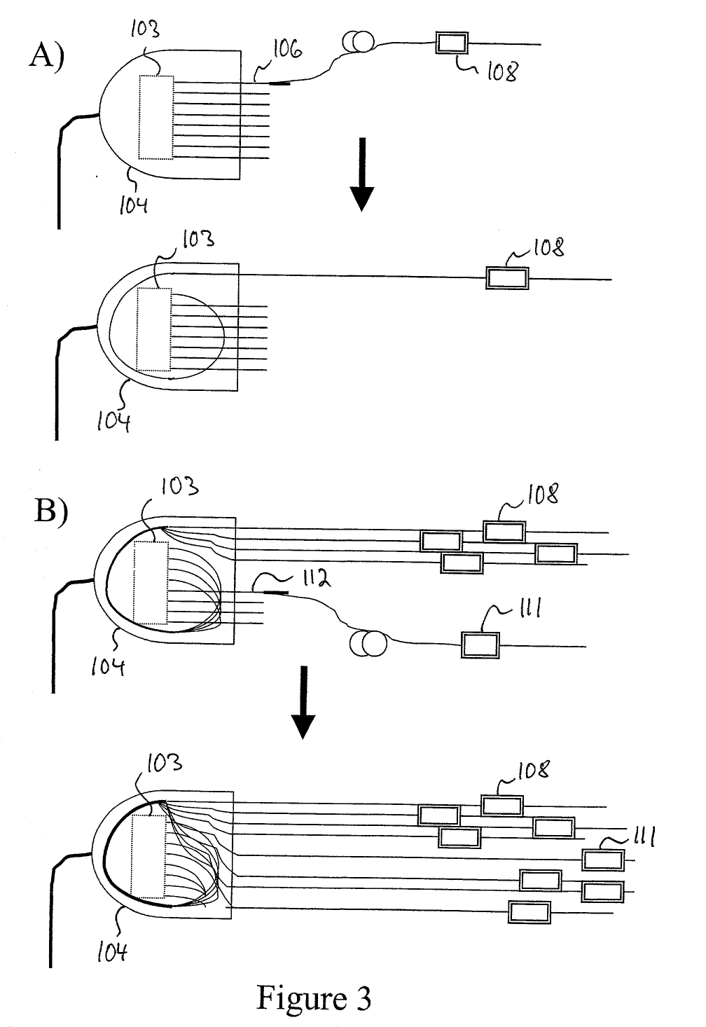

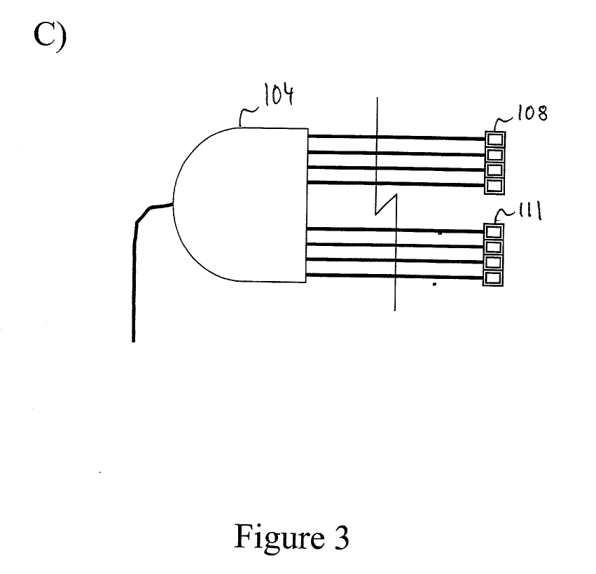

Turning now to FIGS. 3A to E, a process for assembly of a WDM assembly embodying the present invention will be described.

In FIG. 3A, a 1470 nm transmitter laser 108 is spliced to its associated 1470 nm filter output 106 of a WDM filter structure 103 and the fibre connection recoated. Importantly, once the splice has been formed, a desired external fibre link length is “set” through suitable fibre handling of access fibre connection length inside the open casing 104.

It will be appreciated by a person skilled in the art that, accordingly, the various fibre connections between the transmitter lasers e.g. 108 of the assembly, and their associated filter outputs, e.g. 106, can meet desired external length requirements while at the same time allowing for the possibility of unsuccessful splicing steps. Unsuccessful splices require the breaking of the splice and resplicing, and thus result in reduction of fibre length between the components. The fibre handling inside the open casing 104 allows to accommodate the play/variances in fibre lengths between the components, which can thus conveniently be provided initially with a standard fibre length for the fibre connection. This can facilitate a cost effective mess-manufacture of WDM assemblies.

This procedure is repeated for the remainder of the transmitter units. It is noted that the desired external length requirements may be different for different transmitter lasers. All exit ports from the casing 104 may have a different fiber length associated with them. These lengths need to take the following points into consideration in order to determine an accurate length, in an example embodiment:

position of the exit port of that particular fiber from the CWDM module

physical relation of casing 104 to the laser boards and the receiver boards

standard fiber bend radius constraints

physical layout of the fiber trays, if used, and their position's effect on fiber lengths

position layout of the lasers and receivers on their relative boards

Due to only having a very small tolerance of error for the fiber lengths all the above considerations have to be understood and met in order to achieve accurate measurement of fiber lengths. All the fiber looping is carried out within the casing 104 itself. Importantly, it is the ability to do this which allows the approach of handling the fiber externally between the casing 104 and the lasers e.g. 108 and the receivers described below.

This approach does mean that reworking has to be carried out by specialist personnel and all re-splicing is completed internally to the CWDM module. There is no room for external splicing within the module. Importantly, this approach allows the CWDM module with receivers/transmitters attached to be replaced/upgraded in the field with minimum service disruption.

Similarly, the 1610 nm receiver 111 is spliced to its associated 1610 nm filter output 112 and recoated, with accommodation of access fibre length through appropriate fibre handling inside of the open casing 104, as shown in FIG. 3B. The procedure is again repeated for the remainder of the receiver units, again with the fibre handling inside of the filter module 104 accommodating any play/variances due to re-splicing as may be required, to meet external fibre lengths requirements.

The above procedure for transmitter and receiver units, allows the fibre lengths to be predetermined according to the identified design constraints.

As shown in FIG. 3C, in the final assembly 114, the now closed casing 104 is individually fibre connected to the transmitter lasers e.g. 108 and receiver units e.g. 111, which are external to the module 104, with the external fibre lengths meeting individually desired requirements.

Accordingly, it will be appreciated by a person skilled in the art that the method of the preferred embodiment described above with reference to FIGS. 3A to C is suitable for mass manufacture of a WDM assembly from individual optical components, as it combines a desired modularity of the WDM assembly with the ability to meet critical external fibre length requirements. Table 1 is a summary of the predetermined fibre lengths for the transmission lasers of an example embodiment. From the table we can see that the total fiber lengths are different. This is due to the positioning constraints of the components within the WDM network node module. Identifying the constraints and working within them is important because of very small length tolerance of the whole fibre assembly.

TABLE 1

| Wavelength- | Fiber |
|---|---|
| East/West | Length (mm) |
| 1470 nm East | 320 |
| 1490 nm East | 360 |
| 1510 nm East | 350 |
| 1530 nm East | 315 |
| 1550 nm West | 345 |
| 1570 nm West | 360 |
| 1590 nm West | 320 |
| 1610 nm West | 320 |

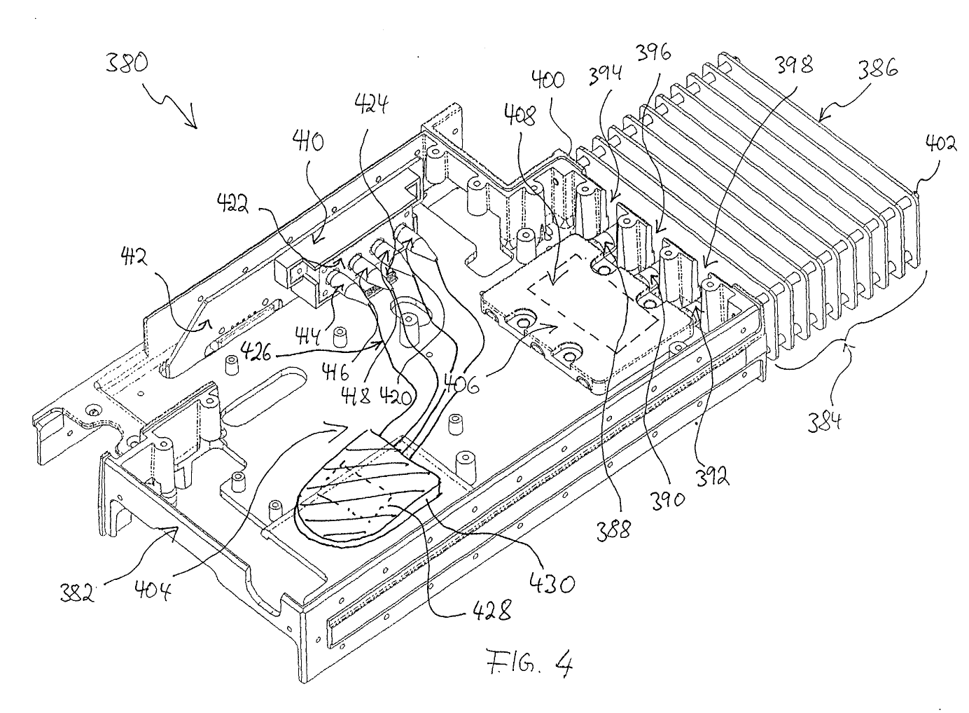

Turning now to FIG. 4, there are shown parts of a WDM network node module 380 comprising a chassis member 382 and a heat sink structure 384. The heat sink structure 384 comprises a plurality of fins e.g. 386 mounted on to three water based heat pipes 388, 390 and 392, extending through slots 394, 396, 398 respectively of a side wall portion 400 of the chassis member 382. The heat sink structure 384 further comprises four protective mounting rods e.g. 402 disposed in a manner such as to relief the heat pipes 388, 390, 392 from excessive load bearing as a result of a force being applied to one or more of the fins 386.

The heat pipes 388, 390, and 392 are mounted inside the WDM network node 380 and onto a main body 404 of the chassis member 382 by way of a thermally conducting mounting bracket 406. A TE device in the form of a thermoelectric conductor/cooler (TEC) 408 is located underneath the mounting bracket 406 and thermally connected to the main body 404 of the chassis member 382.

A local thermal environment structure including, in the example embodiment a laser housing 410 is mounted inside of the WDM network node module 380 by way of a vertically mounted circuit board 412. Four semiconductor laser elements 414, 416, 418, and 420 are mounted in a manner such that their respective junction regions are located substantially inside or immediately adjacent to a thermally conductive base member 422 inserted in the laser housing 410, forming, in the example embodiment, the local thermal environment structure. A second TEC 424 is mounted on the main body 404 of the chassis member 382 and in thermal contact with base member 422 and thus with the laser structure 410.

The laser elements 414, 416, 418 and 420 are individually fibre connected via single fibre links e.g. 426 to a WDM filter structure 428 located inside a casing 430. The casing 430 inturn is mounted on the chassis member 382.

It will be appreciated by the person skilled in the art, that the length of the external fibre links e.g. 426 between the laser elements e.g. 414 and the casing 430 have to meet critical requirements in order to facilitate each of assembly of the WDM network node module 380.

It will be appreciated by a person skilled in the art that the same applies to WDM receivers (not shown) individually connected to the WDM filter structure 428 located inside the casing 430 at appropriate locations depending on the design of the WDM network node module 380.

In the example embodiment illustrated in FIG. 4, the laser drivers (not shown) associated with the lasers 414, 416, 418 and 420 are located outside the laser housing 410, i.e. outside the local thermal environment created within the laser housing 410 (and conductive base member 422). The laser drivers (not shown) in the assembled module will be located on a circuit board (not shown) mounted on the main body 404 of the chassis member 382.

It has been found that the WDM network node module 380 can thus be designed in a manner such that when exposed to an uncontrolled OSP environment of −40 to +65° C. ambient temperature, a temperature range inside of the WDM network node module 380 can range from −40 to +85° C. (due to potential heating from heat generating components). The WDM filter structure 428 and the WDM receivers (not shown) in the example embodiment are capable of tolerating such a temperature range inside the WDM network node module 380. The lasers 414, 416, 418, and 420 on the other hand are maintained at a local environment of narrower range, in the example embodiment 40-50° C. This is achieved through the local thermal environment structure used, and can improve their performance.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. A WDM assembly comprising:
a WDM filter structure for multiplexing and demultiplexing optical signals and having a single fibre common connection for transmitting and receiving a WDM optical signal;
a housing member for the WDM filter structure;
a plurality of E/O transmitter units external to the housing member for receiving a plurality of independent electrical data signals and converting into a plurality of corresponding optical WDM channel signals;
plurality of O/E receiver units external to the housing member for receiving a plurality of optical WDM channel signals and converting into a corresponding plurality of independent electrical data signals;
wherein each of the E/O transmitter units and O/E receiver units is optically connected to the WDM filter structure via a single fibre link; and
wherein excess fibre length in each fibre link is accommodated within the housing member, whereby each fibre length has a predetermined external fibre length between the housing member and the E/O transmitter units and the O/E receiver units.

2. An assembly as claimed in claim 1 wherein the WDM filter structure and the O/E receiver units are capable of tolerating an uncontrolled outside plant (OSP) environment.

3. An assembly as claimed in claims 1 or 2, wherein the assembly further comprises a local thermal environment structure external to the housing member, and arranged, in use, such that each E/O transmitter unit is in thermal communication with the local thermal environment structure.

4. An assembly as claimed in claim 3, wherein the local thermal environment structure is arranged, in use, such that a local environment around each E/O transmitter unit is maintained within a constrained temperature range.

5. An assembly as claimed in claim 4, wherein the constrained temperature range is between 40-50° C.

6. An assembly as claimed in claim 1, wherein the WDM filter structure comprises a plurality of individual filter elements for the demultiplexing and multiplexing.

7. An assembly as claimed in claim 6, wherein the filter elements are discrete components connected via single fibre links.

8. An assembly as claimed in claim 7, wherein the fibre links comprise recoated fibre splices.

9. An assembly as claimed in claims 6 or 7, wherein each E/O transmitter unit is connected to an associated one of the discrete filter elements via the single fibre links.

10. An assembly as claimed in claim 9, wherein the single fibre links between the E/O transmitter units and the associated filter elements comprise recoated fibre splices.

11. An assembly as claimed in claim 10, wherein the recoated fibre splices are located inside the housing member.

12. An assembly as claimed in claims 6 or 7, wherein each O/E receiver unit is fibre connected to an associated one of discrete filter elements inside the WDM filter module.

13. An assembly as claimed in claim 12, wherein the single fibre links between the O/E receiver units and the associated discrete filter elements comprise recoated fibre splices.

14. An assembly as claimed in claim 13, wherein the recoated fibre splices between the O/E receiver units and the filter elements are located inside the housing element.

15. An assembly as claimed in claim 12, wherein at least one of the single fibre links between one O/E receiver unit and its associated filter element comprise an optical tap element located inside the housing element, and the WDM assembly further comprises a management data O/E receiver unit external to the housing element and connected to a tap output of the tap element via a single fibre link for receiving an optical management signal and converting into an electrical management signal.

16. An assembly as claimed in claim 1, wherein the WDM filter structure comprises an integral waveguide device.

17. An assembly as claimed in claim 16, wherein the integrated waveguide device is a planar waveguide device.

18. An assembly as claimed in claims 16 or 17, wherein the fibre links between the O/E receiver units and the WDM filter structure comprise recoated fibre splices.

19. An assembly as claimed in claim 18, wherein the recoated fibre splices between the O/E receiver units and the filter elements are located inside the housing element.

20. An assembly as claimed in claims 16 or 17, wherein the integral waveguide device further comprises a tap element for optically tapping into one of the WDM channel signals, and the WDM assembly further comprises a management data O/E receiver unit external to the housing element and connected to a tap output of the integrated waveguide device via a single fibre link for receiving an optical management signal and converting into an electrical management signal.

22. A method of manufacturing a WDM assembly, the method comprising the steps of:
locating a WDM filter structure for multiplexing and demultiplexing optical signals in a housing member for the WDM filter structure;
optically connecting a plurality of the E/O transmitter units and a plurality of O/E receiver units to the WDM filter structure via a single fibre links; and
accommodating excess fibre length in each fibre link within the housing member, whereby each fibre length is adjusted to a predetermined external fibre length between the housing member and the E/O transmitter units and the O/E receiver units.
